(19) United States
(12) Patent Application Publication
(10) Pub. No.: US 2006/0256104 A1
(43) Pub. Date: Nov. 16, 2006

(54) Videocomputer

(76) Inventors: Sergio Gramer-Quinonez, 10541159 (MX); Cesar Gramer-Quinonez, Chihuahua (MX)

Correspondence Address: BROWDY AND NEIMARK, P.L.L.C.;624 NINTH STREET, NW, SUITE 300, WASHINGTON, DC, 20001-5303, US

(21) Appl. No.: 10/541,159

(22) PCT Filed: Jun. 11, 2003
(86) PCT No.: PCT/MX03/00049

§ 371 Date: May 3, 2006

(30) Foreign Application Priority Data
Jan. 20, 2003 (MX) PA/U/2003/000032

(51) Int. Cl. G06F 17/00

(52) U.S. Cl. 345/418

(57) ABSTRACT

The invention relates to a videocomputer which projects digital sound and video, in particular in vehicles. The invention consists of a computer comprising a large-capacity hard disk and a software program which executes the projection commands, said commands being displayed on a screen and selected using a keyboard. According to the invention, video signals are transmitted from de computer to an audio amplifier and, subsequently, to the loudspeakers, and video signals are transmitted to a video signal splitter and, subsequently, to the televisions. The aforementioned keyboard comprises a button which can be used to turn the computer on and off by remote control. Moreover, dampers are provide in order to protect the hard disk against impact and a support comprising dampers is used to prevent computer from sliding. Files are loaded onto the hard disk from a removable hard disk or from wired or wireless networks and expired files are automatically removed.

### BACKGROUND

In the actuality, local and foreign bus lines and private and commercial airlines offer an entertaining service to their passengers during their trip, with the objective of making it more pleasant. Today, what once was an additional service for the traveler, has become an integral part of the service, making the passenger more demanding about the quality of the digital audio and video, as well as the content of the artistic works, material used to be exhibited by the transportation units.

In consequence, specialized services companies have been created to create an ideal programming for the exhibition of movies, series, musicals, music videos, commercial advertising, social advertising, as well as for all those private companies and government institutions who whish to buy advertisement space to promote a product or service or social announcement via the TV closed circuit in movies, documentaries, series, music videos in transportation lines.

However, it still faces a great deal of problems that have not been solved yet. In consequence, different bus, air, maritime and fixed and semi fixed points enterprises have encountered a great problem regarding the form of exhibition for movies, documentaries, series, music, music videos, commercial advertisings, social announcements in TV closed circuit, to mention only a few of the most important items.

Air and bus lines have encountered a great problem regarding the form of exhibition of movies:

1. High costs of movie rentals.

2. The operator or person in charge of the exhibition of movies, series, documentaries, musicals, music, music video clips, commercial advertisings, social announcements in the TV closed circuit, used to show on his own account or criteria the different forms of exhibition outlined above, jeopardizing the company's image due to the bad quality of the movies shown, as well as because of some lawsuits by the production companies and the copyright owner for the non authorized exhibition of the material.

3. Handling of the videotapes and DVD's by the operator or person in charge was not the most adequate, because he never changed the movie, series, documentaries, musicals, music videos, music, commercial advertisings, social announcements, for their renewal, making the service inefficient.

4. The publicity offered by the land and maritime transportation or fixed or semi fixed points companies for their passengers is not exhibited adequately because the operator does not insert the videotapes with such publicity. Adding to this the high reproduction cost, and the videotape had to be constantly edited.

5. The quality of the audio and video can fluctuate from acceptable to bad quality, and in some cases can lack of quality because they are movies, series, documentaries, music, commercial advertisings, social announcements, music videos which are exhibited constantly, either due the their natural wear or because of the bad handling by the operators, as well as the bad quality of VCR's, DVD's, digital video reader unit, CD's, compact disk unit.

6. Piracy when exhibiting in TV closed circuit, movies, series, documentaries, music, commercial advertisings, social announcements, music videos by the different local and foreign transportation companies, as well as by the operator or person in charge of exhibit them. Overdue movies were also exhibited past their exhibition schedule.

7. The operator or person in charge does not care about following the schedule as indicated, having as a result the problem of showing a 2 hour movie in a trip lasting less than 1 hour, and for trips of more than 2 hours showing 1 hour movies, leaving the passenger totally unsatisfied because of the movie service.

8. Shipping of movies by the distribution house, as well as by the transportation company to their offices has a high cost and also means a waste of time, because of this the schedule could not be met, because the messenger service could be late in the delivery of the material to be exhibited.

9. Since the production houses offer to their distributors the movies, series, documentaries, etc. and at the same time they are re-rented to the transportation company for determined periods of exhibition, they have a due date, which includes the movie transportation time, as well as the labeling. Time costs, since every day that passes in the transportation costs the rent of each movie.

10. High VCR, DVD and CD player maintenance cost.

11. Excessive expenses in personnel for movies control and logistic by the transportation companies.

12. Storage expenses

13. Accountability for the videotapes in charge

14. Operator's distraction when changing movies and music on the road, jeopardizing the passenger's safety.

### OBJECTIVE

Providing equipment for digital audio and video projection in ground, air, and maritime, massive transportation vehicles. In general this is a digital audio and video system with high a data and files storage capacity for an intelligent long lasting programming.

### DESCRPITION OF THE DRAWINGS

FIG. 1: Shows the videocomputer's components and connection system diagram.

FIG. 2: Shows the keyboard details

FIG. 3: Shows the internal Hard Disk Drive and the shock absorbing media for the internal HDD

FIG. 4: Shows the support over which the videocomputer will be mounted in the transportation unit.

### DESCRIPTION

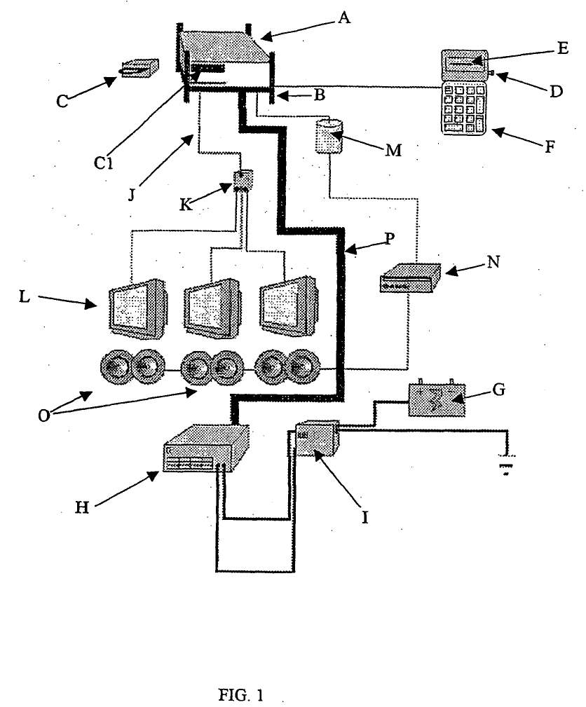

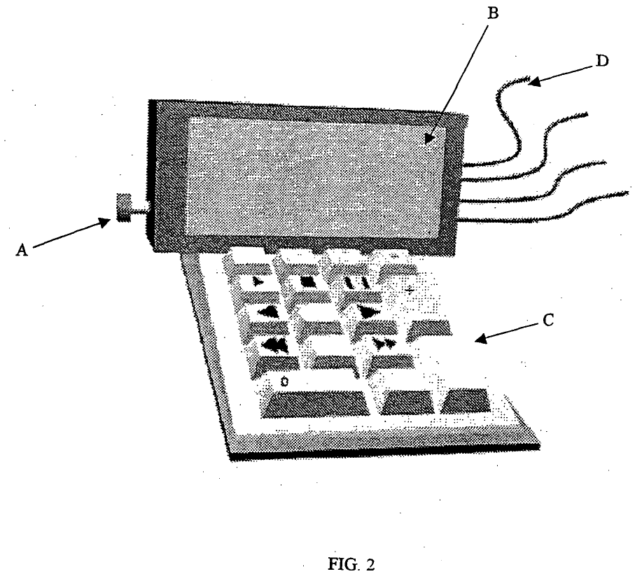

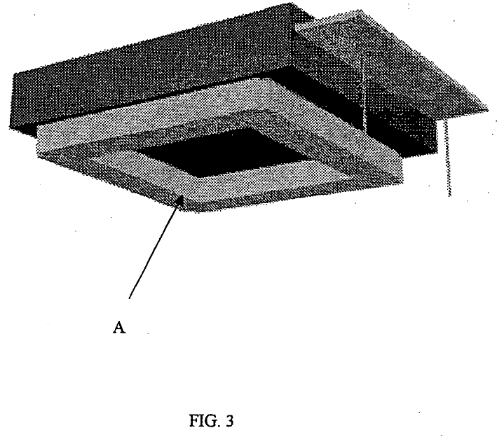

The invention presented refers to a videocomputer which comprises a computer (FIG. 1 a) with the next minimum requirements: minimum storage capacity for 180 hours of audio and video in the hard disk, 256 Mega Bytes RAM and at least a Pentium 4 processor or equivalent at 1.7 Giga Hertz minimum, double ventilation unit, one for the processor and one for the mother board and a shock absorbing device (FIG. 3 a) in the base of the internal hard disk comprised of rubber plates placed points susceptible of movement or vibration to absorb the impact from a movement that could cause malfunctioning (FIG. 3 a). It must include a connection device (Fig. C 1) to connect an extractable hard disk (FIG. 1 c). A remote control power on switch must be available connected to a keyboard panel, (FIG. 1D, FIG. 2 A) the videocomputer also has some ports: as a minimum, has an audio and video output port, a serial port, a PS2 port to connect a keyboard and 2 USB ports.

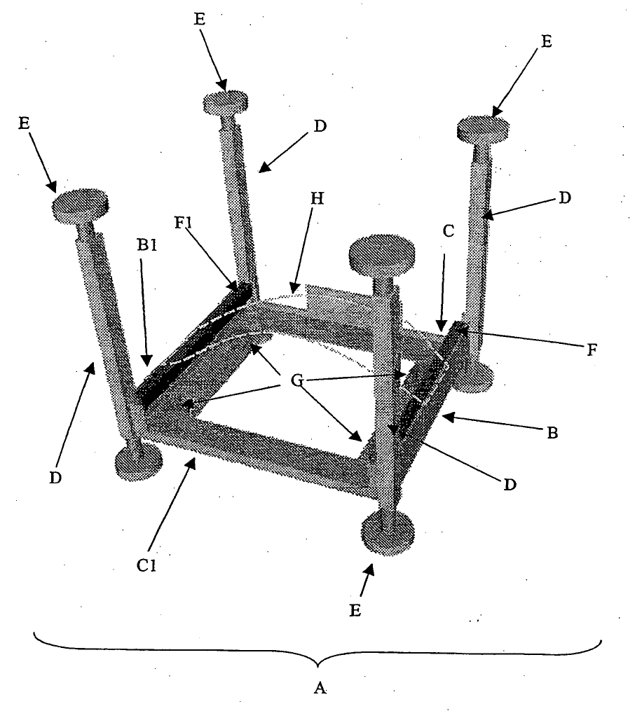

Since the videocomputer's computer will be installed in some mean of transportation, which implicates movement, a supporting base was designed (FIG. 1b, FIG. 4 a) quadrangular in form, which adapts to the computer base size. Each of the four sides of the base has a 90 degree angle flange divided to the top part into two sides located one in front of the other, (FIG. 4 b, Fig. B1), the flange is of a higher height than the one of the two other sides. This height should be high enough to avoid sliding of the computer. In the two other sides (FIG. 4c, Fig. C1), the flange is of less height, this to facilitate the cable connections used in the computer of the videocomputer. On the exterior side of each angle in the base are girders (FIG. 4 d) directed to the top and bottom parts of the base, on which their endings lead to a threaded bore to screw and unscrew a bolt (FIG. 4e), which in its ending has an affixing foot used to adjust the base height and to attach it to the placing spot in the ground transportation unit in the luggage rack located at the front top part inside the transportation unit.

A rubber band is attached, from end to end, (FIG. 4f, FIG. 4f1) by the interior part of the high flange (FIG. 4b, FIG. 4b1), also, in the internal part of the base, circular formed rubber pieces are adhered, (FIG. 4g), being these the resting place of the computer in the support base. These rubber pieces will function as shock absorbers for the computer in the event of rough movement. To gain a better fastening for the computer of the videocomputer to the support's base a flexible band is used (FIG. 4h); it is placed from side to side, fastened by the ends of the high flange.

The videocomputer's software works under Windows 98, NT, 2000 and XP as a minimum or equivalent. The software reproduces any kind of digital video and audio formats. This software has other functions, such as programming the activation or elimination of images and sound to comply with the exhibition periods due dates. It also has the function of establishing the communication for an informative screen for the videocomputer user or operator (FIG. 1e, FIG. 2e), as well as file encrypting and decoding. The commands are executed by the operator or the passengers through a voice command, keyboard (FIG. 1f, FIG. 2 c), connected through a PS2 port in the videocomputer's computer or through some command device, either of voice recognition or interactive screen, (Touch screen), mouse or wireless pointers, as well as any data entry device connected to any port of the videocomputer's computer.

The keyboard or data entry device should include the next minimum basic functions:

START OR PLAY Starts the images and sound execution
STOP Stops the images and sound execution
PAUSE Temporally stop the images and sound execution
FORDWARD The operator can advance the images and sound execution by programmed time blocks,
REWIND The operator can rewind the images and sound execution by programmed time blocks,
NEXT Executes the next action in the programming.
PREVIOUS Executes the previous action in the programming.
ENTER Confirms the solicited action
NUM LOCK Blocks the keyboard to avoid operation by unauthorized persons.
VOL. Turns volume up.
VOL. Turns volume down.
POWER OFF Shuts the system down.

The above commands are shown through a screen (FIG. 1 e), which is connected to the videocomputer's computer via a serial, parallel, or any other port for data transfer. The location of this screen can be, depending on the type of vehicle, integrated to (FIG. 2) or separated from the keyboard. In the event it is integrated to the keyboard, this group would be placed in the operator's area of action, and in the case it is separated from the keyboard, the location would be integrated to the instruments board or in some visible place for the operator.

The power supply for the screen is supplied by the computer or by other source of energy (FIG. 2d.). The remote control power on-off switch (FIG. 2a) for the videocomputer's computer is integrated to the keyboard.

The videocomputer's power supply (FIG. 1g) is generated through the transportation vehicle's power supply, and it could be any of the following:

1.—The transportation vehicle uses batteries that generate 24 volts, which would require the usage of a power transformer (FIG. 1 i) with a 24-volt input and a 12-volt output followed by a power inverter (FIG. 1 h) with a 12-volt input and a 110-volt output, which is the energy requirement for the videocomputer.

2.—The transportation vehicle uses batteries that generate 12 volts, which would require a power inverter (FIG. 1 h) with a 12-volt input and a 110-volt output, which is the energy requirement for the videocomputer.

3.—The transportation vehicle uses batteries that generate 24 volts, which would require a power inverter (FIG. 1 h) with a 24-volt input and a 110-volt output, which is the energy requirement for the videocomputer.

4.—The transportation vehicle uses batteries that generate 24 or 12 volts, and the energy requirement for the videocomputer being of 12 to 24 volts.

### Functioning

The videocomputer's computer processes the information stored in the hard disk, transforming it into video signal, which is sent via a video RCA cable or through any other kind of video cable (FIG. 1j) to a signal splitter (FIG. 1k), which multiplies this video signal to send it to several monitors or televisions placed in the interior of the transportation vehicle. (FIG. 1l), it also processes the information, transforming it into an audio signal with stereo output, primarily directed to an audio filter (FIG. 1m), which has the function of eliminating the noise produced by external agents, sending the cleaned signal to a sound amplifier (FIG. 1n) which distributes it to the loudspeakers (FIG. 1n) in the transportation vehicle.

The videocomputer's computer hard disk will be fed with compressed digital image and sound files through an extractable hard disk drive, (FIG. 1c), previously fed, through a data transfer operation from the extractable disk to the internal hard disk (FIG. 3), once the transfer operation is done, the extractable disk is removed and the videocomputer's computer is ready to process the fed files.

In the same manner, this internal hard disk feeding process (FIG. 3) can be done through a data transfer via wire network, wireless network or broad band internet, USB port or any other kind of port with the capability of connecting to a portable hard disk.

The liberation of the computer's hard disk space is done through the software used to activate and eliminate the images and sound files in accordance to the programmed exhibition.

The videocomputer's computer has software specially designed to operate in the passenger transportation, coordinating the projection of digital images and sound in accordance to the pre-established routes and running time and exhibition times.

To begin the projection the computer must be turned on through the remote control power on switch located in the keyboard (FIG. 2a), next, the screen will ask the operator to enter the command option, starting by the route number and his access code, after this, the start key must be depressed to automatically start the projection. The operator has on his keyboard multiple functions to be used conveniently, as it is to stop, forward, control the volume, pause, next projection, last projection, just by pressing the selected key.

1-3. (canceled)

4. A videocomputer, which comprises a computer; a double ventilation unit, one for the processor and one for a mother board; a shock absorbing device in the base of the internal hard disk, the shock absorbing device comprised of rubber plates placed at points susceptible of movement or vibration to absorb the impact from a movement that could cause malfunctioning thereof; a connection device to connect an extractable hard disk; a remote control power switch connected to a keyboard panel; at least one audio and video output port, one serial port, one PS2 port to connect a keyboard and two USB ports; and a power supply.

5. The videocomputer of claim 4, wherein the computer has a minimum storage capacity for 180 hours of audio and video in the hard disk, 256 Mega Bytes RAM and at least a Pentium 4 processor or equivalent to 1.7 Giga Hertz.

6. The videocomputer of claim 4, including a supporting base which adapts to the computer base size, wherein each of the four sides of the base has a 90 degree angle flange divided to the top part into two sides located one in front to the other, said flange is of a higher height than the one of the two other sides. The height should be high enough to avoid sliding of the computer. In the two other sides the flange is of less height to facilitate the cable connections used in the computer of the videocomputer.

7. The videocomputer of claim 6, wherein the exterior side of each supporting base angle has girders directed to the top and bottom parts of the base, on which their endings lead to a threaded bore to screw and unscrew a bolt which in its ending has an affixing foot used to adjust the base height and to attach it to the placing spot in the ground transportation unit in the luggage rack located at the front top part inside the transportation unit.

8. The videocomputer of claim 7, wherein a rubber band is attached, from end to end, at the interior part of the higher flange and in the internal part of the base, and circular formed rubber pieces are adhered to be the resting place of the computer in the supporting base, which function as shock absorbers for the computer in the event of rough movement.

9. The videocomputer of claim 8, wherein a flexible band is placed from side to side of the supporting base to better fasten the computer of the videocomputer.

10. The videocomputer of claim 4, wherein the power supply is generated through the transportation vehicle's power supply generating 24 volts, requiring the usage of a power transformer with a 24-volt input and a 12-volt output followed by a power inverter with a 12-volt input and a 110-volt output.

11. The videocomputer of claim 4, wherein the power supply is generated through the transportation vehicle's power supply generating 12 volts, requiring a power inverter with a 12-volt input and a 110-volt output.

12. The videocomputer of claim 4, wherein the power supply is generated through the transportation vehicle's power supply generating 24 volts, requiring a power inverter with a 24-volt input and a 110-volt output.

13. The videocomputer of claim 4, wherein the power supply is generated through the transportation vehicle's power supply generating 24 or 12 volts.

14. The videocomputer of claim 4, further including a keyboard in the operator's area of action, for controlling the videocomputer operation.

15. The videocomputer of claim 4, further including a screen connected to the videocomputer's computer via a serial, parallel, or any other port for data transfer, and powered by the computer or by other source of energy.

16. The videocomputer of claim 15, wherein the screen is integrated to the keyboard placed in the operator's area of action.

17. The videocomputer of claim 15, wherein the screen is separated to the keyboard integrated to the instruments board or in some visible place for the operator.

18. The videocomputer of claim 4, including a remote control power on-off switch integrated to the keyboard.

19. A videocomputer comprising a computer, a software, a hard disk, an extractable hard disk drive, a video cable, a signal splitter, an audio filter, a sound amplifier, wherein the videocomputer's computer hard disk will be fed with compressed digital image and sound files through the extractable hard disk drive previously fed, a data transfer via wire network, wireless network or broad band internet, USB port or any other kind of port with the capability of connecting to a portable hard disk; said computer processes the information stored in the hard disk, transforming it into video signal, which is sent via a video cable to a signal splitter which multiplies this video signal to send it to several monitors or televisions placed in the interior of the transportation vehicle; said computer also processes the information, transforming it into an audio signal with stereo output, primarily directed to an audio filter, which has the function of eliminating the noise produced by external agents, sending the cleaned signal to a sound amplifier which distributes it to the loudspeakers in the transportation vehicle; and wherein the projection of the digital images and sound is coordinated by the software in accordance to the pre-established routes, running time and exhibition times in the passenger transportation.
